(19) United States
(12) Patent Application Publication
(10) Pub. No.: US 2003/0033501 A1
(43) Pub. Date: Feb. 13, 2003

(54) Processors for rapid sequence comparisons

(76) Inventors: Laurence H. Cooke, Los Gatos, CA (US); Stephen Eliot Zweig, Los Gatos, CA (US)

Correspondence Address: STEPHEN E. ZWEIG, 224 VISTA DE SIERRA, LOS GATOS, CA, 95030, US

(21) Appl. No.: 10/145,468

(22) Filed: May 13, 2002

Related U.S. Application Data
(60) Provisional application No. 60/293,682, filed on May 25, 2001.

(51) Int. Cl. G06F 15/00

(52) U.S. Cl. 712/32

(57) ABSTRACT

Improved processors and processing methods are disclosed for high-speed computerized comparison analysis of two or more linear symbol or character sequences, such as biological nucleic acid sequences, protein sequences, or other long linear arrays of characters. These improved processors and processing methods, which are suitable for use with recursive analytical techniques such as the Smith-Waterman algorithm, and the like, are optimized for minimum gate count and maximum clock cycle computing efficiency. This is done by interleaving multiple linear sequence comparison operations per processor, which optimizes use of the processor's resources. In use, a plurality of such processors are embedded in high-density integrated circuit chips, and run synchronously to efficiently analyze long sequences. Such processor designs and methods exceed the performance of currently available designs, and facilitate higher dimensional sequence comparison analysis between three or more linear sequences.

### BACKGROUND OF THE INVENTION

1. Field of the Invention

The invention relates to improved electronic integrated circuits by which two or more long linear arrays (strings) of characters may be rapidly compared for relationships. In one application, the linear arrays of characters are biological sequences such as nucleic acid sequences or protein sequences, and the relationships are evolutionary relationships.

2. Description of the Related Art

This application claims the priority benefit of provisional patent application 60/293,682 “Processors for rapid sequence comparisons”, filed May 25, 2001.

The genomes of living organisms typically contain between one and three billion bases of DNA. With each generation, mutations in DNA can occur, and with the progression of time, changes can accumulate to the point where individual genes can change their function. Eventually, this genetic divergence leads to the creation of entirely new species.

Biologists and biomedical researchers often gain considerable insight as to the function of an unknown gene by comparing its sequence with other genes that have similar sequences and known functions. However when more remotely related genes are compared, the DNA sequence that the genes may have originally shared in common may become altered to the point where these relationships are difficult to distinguish from the random background of chance DNA sequence alignment.

Recently, methods for accumulating massive amounts of genetic DNA sequence information have been developed. Because considerable information may be found by comparing the DNA sequences between different genes and organisms, major efforts are underway to sequence the DNA from many different human individuals, and many different species. Due to the high speed of modem sequencing technology, data is now accumulating at a rate vastly in excess of the ability of researchers to interpret it. Thus there is considerable interest in computerized “bioinformatics” methods to automate the difficult process of interpreting this massive amount of data.

Although computer processors designed for general-purpose use have made remarkable improvements in speed and performance in recent years, they are still much too slow for many bioinformatics purposes. For example, to completely compare just two genomes at the simplest level of comparison would require a computer system to construct a two-dimensional matrix, where each side has about 3×10⁹ elements. At a minimum, this matrix would take about 9×10¹⁸ calculations to complete. Assuming each calculation was done in one clock cycle of a typical 1 gigahertz modem computer microprocessor, this matrix would take 9×10⁹ seconds to complete. This is approximately 285 years. If three genomes were compared by this method, the resulting three-dimensional matrix would have 2.7×10²⁷ elements, and would take about 855 billion years to compute.

Because insight into genetic function and relationships plays a key role in modem medical research and drug development, there is a high degree of interest in finding improved electronic devices and methods to speed-up bioinformatic sequence comparisons.

### PRIOR ART

General-purpose computer processors are designed for flexibility, and thus use most of their internal circuitry for general-purpose instructions that are useful for a wide variety of situations. However whenever a more limited set of functions must be done at high frequency, it is often advantageous to employ special purpose logical circuits designed to optimize a more limited set of functions. This is often done for digital signal processors. Such digital signal processors may be optimized to do specialized algorithms for video signals, telecommunications signals, and the like.

To aid in the development of circuits (“chips”) to facilitate high-speed processing of fixed algorithms, field programmable gate array (FPGA) circuits are often used. FPGA circuits are composed of a plurality of simple logical elements, and programmable means to dynamically rewire the connections between the various logical elements to perform different specialized logical tasks. Often this is accomplished by fuse—antifuse circuit elements that connect the various FPGA logical circuits. These fuse—antifuse elements can be reconfigured by applying appropriate electrical energy to the FPGA external connectors, causing the internal FPGA logical elements to be connected in the appropriate manner.

An alternate way to produce custom integrated circuit chips suitable for the implementation of custom algorithms is by more standard chip production techniques, in which a fixed logical circuit is designed into the very production masks used to produce the chip. Because such chips are designed from the beginning to implement a particular algorithm, they often can be run at a higher logic density, or faster speed, than more general purpose FPGA chips, which by design contain many logical gates that will later prove to be redundant to any particular application.

Often, custom chips are used for parallel processing tasks. Problems amenable to parallel processing may often be subdivided into smaller problems, and each smaller problem assigned to a subunit. If the problem is divided into multiple parts, and each part assigned to a subunit, wherein each subunit performs a logical subpart of the larger problem, it is said to have been divided over multiple processors.

Depending upon the problem at hand, and the means chosen for solution, custom integrated circuit chips can be designed to tackle logical problems by various means. This can range from the entire chip being devoted to one complex and powerful processor circuit containing hundreds of thousands or millions of gates, to the entire chip being devoted to numerous but less capable processors, each individual processor element employing only hundreds or thousands of gates.

### Bioinformatics Algorithms

The typical goal of a bioinformatic genetic sequence comparison algorithm is to report the existence of any statistically significant similarities between two or more genetically different sequences, and to show specifically which elements are similar, and which elements are different.

As evolution progresses, DNA can mutate in many different ways. A DNA base may mutate to a different DNA base by mutation. Alternatively, one or more DNA bases may be either inserted or deleted in a sequence. As evolution progresses, the net sum of many individual mutation, insertion, and deletion changes can potentially reduce the similarity between any two sequences to a very low level. An additional problem rises because the basic genetic code contains only four distinct bases: adenine “A”, thymine “T”, cytosine “C” and guanine “G”. The distribution of these four bases in the genome is non-random, and occasionally, regions will be preferentially enriched in one or more of these bases. Thus even randomly chosen genetic sequences will likely contain some similarities simply due to random base match ups. However such random base matches is of limited biological interest, and usually represents an unwanted statistical “noise” background to all genetic analysis.

Typically, biological sequences, such as DNA, RNA, or protein sequences are stored as linear arrays of characters, where each character corresponds to a DNA, RNA, or protein base, element, or residue. Such linear character arrays are often referred to as “strings”.

The most useful and practical bioinformatics algorithms are those that can find faint but genuine similarities between originally related sequences that have been altered by many mutation, insertion and deletion events, while rejecting random “noise” similarities. Here a number of algorithms have been proposed. Some algorithms, such as BLAST and FASTA, emphasize computational speed at the expense of low-signal-detection ability. Other algorithms, such as the Smith-Waterman algorithm, maximize low-signal-detection ability but are computationally extremely intensive.

In general, if computational means and time permit, the superior low-signal-detection ability of Smith-Waterman like algorithms are preferred because they can uncover faint but statistically valid homologies that faster but less thorough algorithms may miss. Since a new biological insight can potentially lead to discoveries, such as a new drug, that are of significant medical and economic importance, faster methods of performing Smith-Waterman like algorithms are of considerable interest to biomedical research.

The Smith-Waterman algorithm, and related algorithms of this type (such as Needleman-Wunach, etc.) are recursive in nature. They work by considering all possible alignments between two different target sequences, including alignments due to potential insertions and deletions. Their recursive nature is due to the fact that they operate by building upon a history of prior best alignments. In essence they are functions that call themselves over and over. For brevity, discussions here will focus on the Smith-Waterman algorithm as a specific example, however it should be understood that the methods and techniques here could be used with a variety of different comparison functions.

The Smith-Waterman algorithm starts by first considering an alignment between the first elements of the two sequences that it is comparing. It assigns a positive score if the elements (nucleic acid bases) are similar and a zero score if the bases do not match. The algorithm then progresses forward one base and checks if the second elements in the two sequences match (which would occur if the two sequences have homology in this area). If so, another positive score is added to a mathematical matrix cell location that represents the result of this particular comparison. If the two bases do not match, a negative “penalty” score is added to this particular matrix cell location. The algorithm also considers the possibility that one sequence may have had a deletion relative to the other (or alternatively one sequence has an insertion relative to the other). It does this by determining if the second element of one sequence might better match with the first element of the other sequence. If so, this successful match is given a positive score and put into the cell location of the matrix that describes this particular comparison. Because DNA insertions or deletions are less common than simple mutations, such a match is generally a less favored possibility, and is given a lower weight. Thus potential sequence match-ups that would require the assumption that the sequences had undergone many insertion or deletion events are given progressively less weight as the number of potential insertions or deletions grows.

Thus when the two sequences align (are homologous) over a region at a level that is above the random “noise” alignment level, this region of sequence homology will be given a Smith-Waterman score that progressively grows as the number of correct match-ups grows. At the end of the analysis, a two dimensional matrix full of potential Smith-Waterman alignments is constructed. The “best fit” sequence alignment is then found by finding the matrix cell location with the best score, and then tracing back along the chain of previous best fits until the chain ends.

The mathematical form of the Smith-Waterman function is discussed in detail in “Identification of common molecular subsequences” by Smith and Waterman, J. Mol. Biol. 147, 95-197 (1981), the disclosures of which are incorporated herein by reference.

A brief discussion of the algorithm, and an example of its use, are shown below:

Given two sequences, “a” and “b”, with consecutive elements in the sequences represented as “i” for sequence a, and “j” for sequence b, then construct a two dimensional matrix of “a×b”, and populate the matrix according to the algorithm:

| | a1 | a2 | a3 | a4 | a5 |
|---|---|---|---|---|---|
| b1 | | | | | |
| b2 | | 2, 2 | 3, 2 | | |
| b3 | | 2, 3 | 3, 3 | | |
| b4 | | | | | |
| b5 | | | | | |

Here, the contents of matrix cell location SW(i,j) is computed using the formula

SWᵢⱼ=max{SW_{i-1,j-1}+s(aᵢ,bⱼ); SW_{i-k,j}+gⱼ; SW_{i,j-k}+gᵢ; 0}

As an example, for cell location [3,3], which represents the results of the comparison between a3 and b3, Swi−1,j−1+s(ai,bi) represents the value passed from the previous best alignment from cell [2,2] (results of comparison a2 vs b2) added to the results from comparing a3 vs b3. If both cell [2,2] and [3,3] contain positive matches, the net result will be the sum of the two, and a larger score number will result. This can be used by the later traceback algorithm to see that good homology can be found between both a2 vs b2 and a3 vs b3.

Suppose however, that there was a gap in one of the sequences, and that [a1, a2, a3, a4, a5] vs [b1, b2, b3, b4, b5] now becomes [a1, a2, a3, a4, a5] vs [b1, new b2 (old b3), new b3 (old b4), new b4 (old b5)]. Then whereas before the deletion, a3 vs b3 would have been a match, now after the deletion, a3 is not a match vs new a3 (old b4). Rather, a3 is now a match vs new b2 (old b3). This potential relationship can be determined by examining the contents of cell [3,2], which shows up in the Smith-Waterman formula as Si,j−k+gj. If this gives a higher match than the other possible combinations, then the possibility that there has been a deletion should be given higher weight.

Here, the “k” elements allow for the consideration that more than one base has been deleted.

In a similar manner, the formula considers deletions in the other string as well through the Si−k,j+gk part of the formula.

The Smith-Waterman formula can be “turned” by assigning greater or lesser coefficients to matches vs non-matches. It can also be tuned by assigning greater or lesser coefficients to deletion and insertion events. Since such deletions or insertions are generally less common, these are usually given negative weighting factors.

After the matrix is computed, the maximum cell location is used as the starting point of the analysis, and the maximum values are then traced back until 0 is reached. This traced back matrix then corresponds to the region of maximum homology between the two sequences.

It should be noted that this calculation is recursive in nature. That is, the algorithm works by calling itself numerous times. As a result, it is very computationally intensive to perform this calculation on standard computers. Nonetheless, due to its high ability to find biologically interesting homologies between biological sequences, this algorithm is widely used in bioinformatics.

Due to computational limitations, essentially all prior art has focused on comparing only two sequences at a time, (using two-dimensional Smith-Waterman analysis, or other type of 2D analysis). However biologists are well aware of the importance of studying the relationships between three or more different sequences. Studying the relationships between many related genes allows researchers to determine similarities and differences between genes, and make inferences as to the function of new genes. As discussed in chapter 8“Practical Aspects of Multiple Sequence Alignment”, by A. Braxevanis (published in “Bioinformatics, A practical guide to the analysis of genes and proteins” by Baxevanis and Ouellette, Wiley Inter-Science, New York, 1998), a number of computerized methods of multiple sequence alignment are known in the art. All, however, rely upon first performing multiple 2D analysis to first discover any relationships, and then summing the results of many different 2D analysis using logic such as: “if A is related to B, and B is related to C, then A must be related to C even if a direct 2D analysis of A versus C shows no detectable homology. Examples of such prior art for multiple sequence alignment include programs incorporating algorithms such as “CLUSTAL W”, MULTIALIN, BLOCKS, MOST, PROBE, and the like.

Although, possibly due to computational limitations, there appears to be no prior art teaching the desirability or methods of doing higher dimensional sequence comparisons between three or more target sequences with unknown homology, such comparisons would appear to be desirable. This is because of the nature of biological DNA sequence divergence. A single ancestral DNA sequence will typically, after genetic divergence into different organisms, undergo mutations, insertions, or deletions in different places. By making use of consensus logic (“two out of three” algorithms, etc.), faint low-homology matches between distantly related DNA sequences may be discovered that might otherwise be missed using conventional multiple 2D approaches. For example, consider four sequences. If 2D analysis can demonstrate that sequences A, B, and C are each homologous to sequence D, yet fail to detect any homology when A, B, and C are each compared to one another, then the relationship between A, B and C will not be discovered by 2D analysis if sequence D is not available. By contrast, a more comprehensive 3D analysis may uncover the relationship between sequences A, B and C even when sequence D is unavailable.

As previously discussed, even two-dimensional Smith-Waterman type analysis tax current general-purpose computer systems past their limits. Thus there have been prior attempts have to implement custom integrated circuit chip systems specifically designed to speed-up this type of bioinformatic algorithms.

The simplest method to speed up calculations of this nature is to use more computer processors. The dot matrix comparison programs of Zweig “Analysis of large nucleic acid dot matrices on small computers”. (Nucleic Acids Res. 1984 Jan 11;12 (1 Pt 2): 767-76) were designed to allow larger sequence comparisons to be broken up into smaller chunks and run on multiple unnetworked computers. Other early work in this field includes Collins and Colson, “Applications of parallel processing algorithms for DNA sequence analysis” (Nucleic Acids Res. 1984 Jan 11;12 (1 Pt 1): 181-92), as well as Bernstein “Using spreadsheet languages to understand sequence analysis algorithms” (Comput Appl Biosci 1987 Sep;3(3):217-21).

In addition to multiple unnetworked computers, calculations may also be done by dividing the problem up and passing parts of the calculation to networked computer processors. This network of computer processors can be a specialized multi-processor computer, as discussed in “Supercomputers and biological sequence comparison algorithms” by Core et. al., (Comput Biomed Res 1989 Dec;22(6):497-515). Alternatively networks of conventional computers can also be used for this purpose, as discussed in Barton “Scanning protein sequence databanks using a distributed processing workstation network”, (Comput Appl Biosci 1991 Jan;7(1):85-8).

To proceed still further, one obvious solution is to embed many general-purpose microprocessor circuits onto one chip, and run these general-purpose microprocessors simultaneously. However since general purpose microprocessors are typically not optimized to perform any specific computational task, this solution is inefficient because a general purpose microprocessor typically contains extra circuitry that is unneeded in any specific implementation. Further, general-purpose microprocessors typically require more clock cycles to perform a given computational task than a computational circuit dedicated to a specific problem.

As a result, there has been interest in designing computational circuits optimized for specific computational problems, and then embedding a plurality of such optimized circuits into integrated circuit chips in order to address complex problems by many simultaneous computations. There are a number of prior examples of this type of approach.

U.S. Pat. No. 5,168,499 teaches fault detection methods to produce reliable operation of multiple instances of a specific type of processor on a VLSI sequence analysis chip.

U.S. Pat. Nos. 5,632,041 and 5,964,860 teach a 400,000 transistor, 100,000-gate custom VLSI chip composed of sixteen instances of a specific type of processor design, described in FIGS. 11, 12 and 13 of that patent. These patents teach a type of specialized processor design in which each processor is partially optimized to do Smith-Waterman type calculations. However the design still requires a fair number of clock cycles per Smith-Waterman cell calculation.

U.S. Pat. No. 5,873,052 teaches computer processing methods optimized for distinguishing between different nucleic acid sequences that have been previously identified as being highly related.

It is evident that ganging up many custom chips (each employing a plurality of processors) into a larger computational system will further enhance processing speed. Here a number of methods may be used. In addition to the methods taught by the '041 and '860 patents, U.S. Pat. No. 6,112,288, teaches alternative pipeline methods useful for configuring arrays of multiple processor chips into a larger overall system.

Other alternative methods of performing sequence analysis, previously known in the art, include “content addressed memory techniques”. For example, U.S. Pat. No. 5,329,405 teaches content addressed memory circuitry methods for finding regions of exact sequence matches between two given sequences. However such methods are not well suited to perform high-sensitivity comparisons where the various sequences may have multiple mutations, insertions, or deletions.

Commercial embodiments of the prior art can be found in systems by Paracel and TimeLogic. For example, Paracel Corporation (Pasadena, Calif.) produces the GeneMatcher2™ genetic analysis system, based upon custom VLSI sequence analysis chips. TimeLogic Corporation (Incline Village, Nev.) produces the DeCypher™ genetic analysis system, based upon custom FPGA chip technology.

Although prior art has attempted to facilitate Smith-Waterman analysis by a variety of specialized processor techniques, such systems still cannot obtain the speed needed to perform many biologically interesting analyses. Additionally, no-doubt due to processing speed limitations, there appears to be no prior art whatsoever on special purpose electronic systems optimized for performing multi-dimensional Smith-Waterman type analysis. Thus the need for improved equipment and methods of computer sequence analysis is apparent.

### SUMMARY OF THE INVENTION

In order to appreciate how the present invention differs from prior art, and why these differences are advantageous, a discussion of the relative computational efficiencies of the various prior art techniques is in order.

Previous workers have attempted to implement flexible custom sequence analysis integrated circuit chips composed of either multiple processor units on one chip, or alternatively using dynamically reconfigurable logical elements using FPGA technology. However such flexibility comes at a cost. Processor elements must contain additional gate elements and/or operate over many clock cycles in order to store and retrieve instructions and data elements from registers, and thus tend to be gate and clock cycle inefficient. Field programmable logical circuits must, by necessity, contain many redundant gates that are unused in any particular programmed logical application, and thus are also quite gate inefficient. In either event, for any given chip design with a given number of gates and clock speed, these inefficiencies dramatically reduce the maximum potential computational speed.

The performance damaging effect of gate inefficient or clock cycle inefficient designs can be readily appreciated. The ideal circuit design will calculate as many Smith-Waterman cell locations as possible per integrated circuit chip and per clock cycle. Typically one processor will be responsible for updating the contents of one Smith-Waterman matrix location cell. Under these conditions, if all cells update with the same number of clock cycles, then an integrated circuit with 400,000 logical gates divided into 10 40,000 gate-sized Smith-Waterman processors will operate at 10×lower efficiency than a 400,000 logical gate chip divided into 100, 4,000 gate-sized Smith-Waterman processors. Similarly, a 100 mHz integrated circuit chip running with processors that require 40 clock cycles per Smith-Waterman cell calculation will operate at 10×lower efficiency per processor than a 100 mHz integrated circuit chip running with processor units that require only 4 clock cycles per Smith-Waterman cell calculation.

We have found that using processor units with both low gate counts, and good clock cycle efficiency, efficiencies of nearly 25-100× may be achieved over alternative designs. This gain in processing capability in turn enables more sophisticated types of genetic analysis, hitherto infeasible on conventional computational systems.

As previously discussed, FPGA circuits for genetic analysis are taught in the commercially produced DeCypher system, produced by TimeLogic Corporation, Incline village, Nev. According to TimeLogic's most recent (2001) product literature, the most recent embodiment of this prior art system incorporates six logical Smith-Waterman processors per 250,000 gate Altera Flex 10 K FPGA chip (EPF10K250A), and operates at an effective calculation speed of 52,000,000 Smith-Waterman cell updates per second per processing element subunit. Each processor requires approximately 42,000 FPGA gates. The processor efficiency, in terms of Smith-Waterman cell updates per logical gate per second, is about 52,000,000/42,000 or about 1250 Smith-Waterman cells per logical gate per second.

By contrast, the VLSI circuit multiple processor approach is taught in the commercially produced GeneMatcher2 system, produced by Paracel Corporation, Pasadena, Calif.

According to the most recent product literature (2001), the most recent embodiment of this prior art system incorporates 192 logical Smith-Waterman calculating subunits per 30,000,000-transistor VLSI chip. Each processor requires 39,000 gates, and each processor operates at a calculation speed of 10,000,000 cell updates per second. The efficiency, in terms of cell updates per logical gate per second is about 10,000,000/39,000=256 Smith-Waterman cells per logical gate per second.

Although different custom processors have different efficiencies, all custom processors exhibit Smith-Waterman calculation efficiencies that vastly exceed those of conventional, general-purpose processors. A comparison to general-purpose microprocessors can be found in the work of Rognes and Seeberg in “Six-fold speed-up of Smith-Waterman sequence database searches using parallel processing on common microprocessors”. Bioinformatics 2000 Aug;16(8):699-706. Here, they report on a highly optimized parallel Smith-Waterman algorithm running on a conventional Pentium III processor at 500 MHz. This achieved 150,000,000 cell updates per second. The Pentium III chip contains one computing unit, with approximately 28,000,000 transistors (7 million gates). Thus the efficiency is 150,000,000/7,000,000 or about 21 Smith-Waterman cells per logical gate per second, vastly lower than even the slowest custom processors.

By contrast, systems using the concepts taught in this invention, 2 dimensional Smith-Waterman calculating processor units can be implemented at approximately 6,500 gates per subunit, and can operate at over four times the clock speed as the DeCypher FPGA system (approximately 187,000,000 cell updates per second). The efficiency, in terms of cell updates per logical gate per second is over 28,000 Smith-Waterman cells per logical gate per second. Thus for equal integrated circuit gate counts and clock speeds, the design of this invention produces calculation efficiencies about 20-40 times higher than prior art.

In the first aspect of the invention, improved interweaving methods to construct efficient Smith-Waterman type processor calculating circuits, suitable for nucleic acid analysis, protein analysis, or general character similarity analysis between two strings are disclosed.

In a second aspect of the invention, methods for doing higher dimensional comparison analysis between three or more input strings (genetic sequences) are taught.

In a third aspect of the invention, integrated circuit chips containing multiple hardwired complex logical circuits that accomplish higher dimensional comparison analysis between three or more input strings (genetic sequences) are disclosed.

### BRIEF DESCRIPTION OF THE DRAWINGS

FIG. 1 illustrates the inefficiencies of the prior art, by showing the order in which the processor components are utilized serially over one clock cycle, thus limiting the speed of the processor.

FIG. 2 shows an improved processor, designed to perform one cell of a Smith-Waterman calculation, may be constructed following the teachings herein.

FIG. 3 shows how multiple processors from FIG. 2 may be interlinked on an integrated circuit chip capable of performing a multi-element Smith-Waterman analysis, following the teachings of prior art.

FIG. 4 shows a processor of the present invention that utilizes interleaving techniques to improve efficiency.

FIG. 5 shows how multiple processors of the present invention may be interlinked on an integrated circuit chip capable of performing a multi-element Smith-Waterman analysis.

FIG. 6 shows some of the efficiency improvements that may be gained by following the teaching taught herein. Here, the order in which the improved processor elements are utilized over multiple clock cycles is shown.

FIG. 7 shows a conceptual diagram of how higher dimensional Smith-Waterman like analysis may be performed. Here, a three dimensional analysis with three different input strings (genetic sequences) is shown.

FIG. 8 shows a three-dimensional processor of the present invention

FIG. 9 shows how multiple three-dimensional processors of the present invention may be interlinked on an integrated circuit chip capable of performing a multi-element three-dimensional Smith-Waterman type analysis.

FIG. 10 shows a three-dimensional processor of the present invention that utilizes interleaving techniques to improve efficiency, in the same fashion as FIG. 4.

FIG. 11 shows the details of the functions shown in FIG. 10.

FIG. 12 shows how multiple processors of the present invention may be interlinked on an integrated circuit chip capable of performing a multi-element, three-dimensional Smith-Waterman analysis

### DETAILED DESCRIPTION OF THE INVENTION

Prior art processors contain a variety of subcomponents (adders, comparators, registers, and the like) and require a number of clock cycles to complete an analysis. Because the analysis requires multiple clock cycles, only a fraction of the processors' subcomponents are used during each clock cycle. Those processor components that are unused in any given clock cycle represent wasted resources. If these components are not fully utilized, then efficiency can be improved by using fewer components per processor, and putting more processors on a chip; redesigning the processor to more fully utilize all components by pipelining the operations, or a combination of the two.

We have found that by employing novel and improved processor designs that make more efficient use of processor subcomponents, significant improvements in calculating efficiency over the prior art are possible. Large-scale bioinfomatic systems of the prior art typically can cost from millions to hundreds of millions of dollars to implement. These systems, in turn, are used to generate leads for new drug discovery efforts. Since new drugs can produce revenues the billion-dollar range, the economic benefits of improved processor design (lowered computing costs, more drug leads) should be evident.

By use of these improved designs, a larger number of processor units may be placed on integrated circuit chips, and correspondingly faster processing may be done. Use of the improved processor units also enables practical circuits to be constructed that, for the first time, enable higher dimensional (three dimensions or more) sequence analysis to be a practical analytical option.

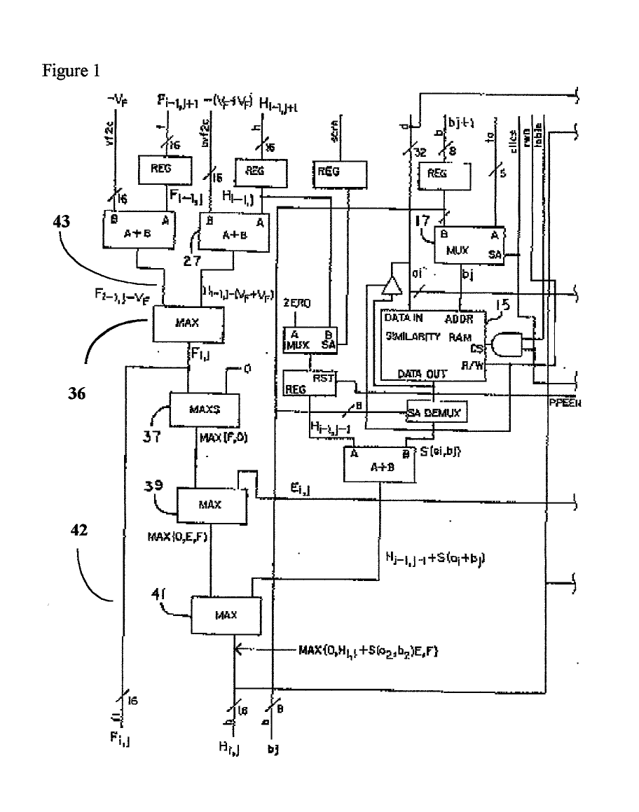

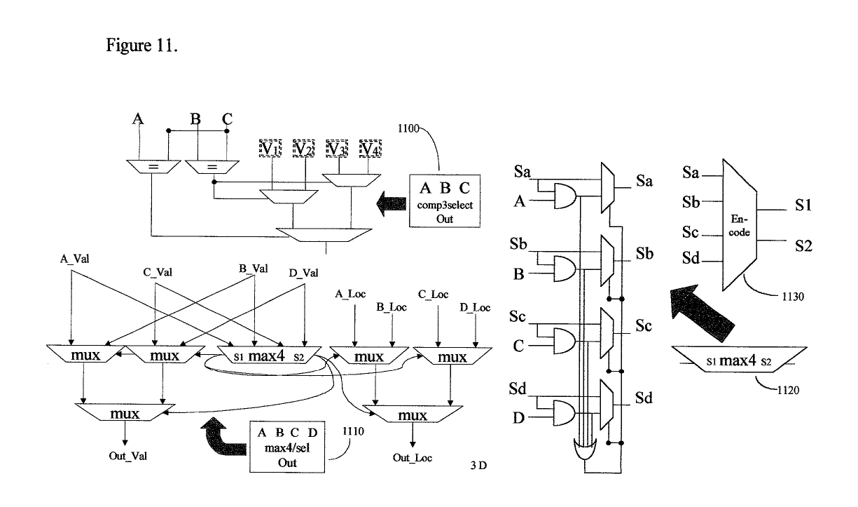

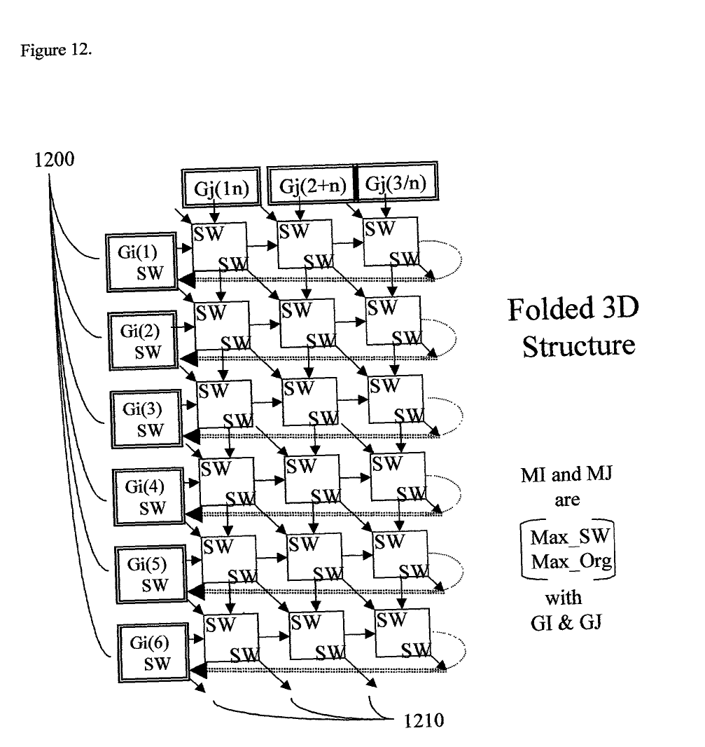

FIG. 1 shows the order in which the various processor components are used following the teachings of prior art, taught in FIGS. 11 and 12 of U.S. Pat. Nos. 5,632,041 and 5,964,860. Note that many processor components are idle for most of the clock cycles during the completion of one Smith-Waterman cell analysis. During the clock cycles from the start of the operation, and the computation of the final Smith-Waterman value, most of the subunits are used only a small fraction of the time. Typically many subunits are idling while either waiting their turn, or after their turn. Note that the path in FIG. 1 from Hi−1,j+1 at the top, down to Hi,j at the bottom, is used to calculate the completion of one Smith-Waterman cell analysis. Unfortunately the signals must propagate through an adder [A+B] (27), three Max functions (36, 39, and 41) and one Maxs function (37).

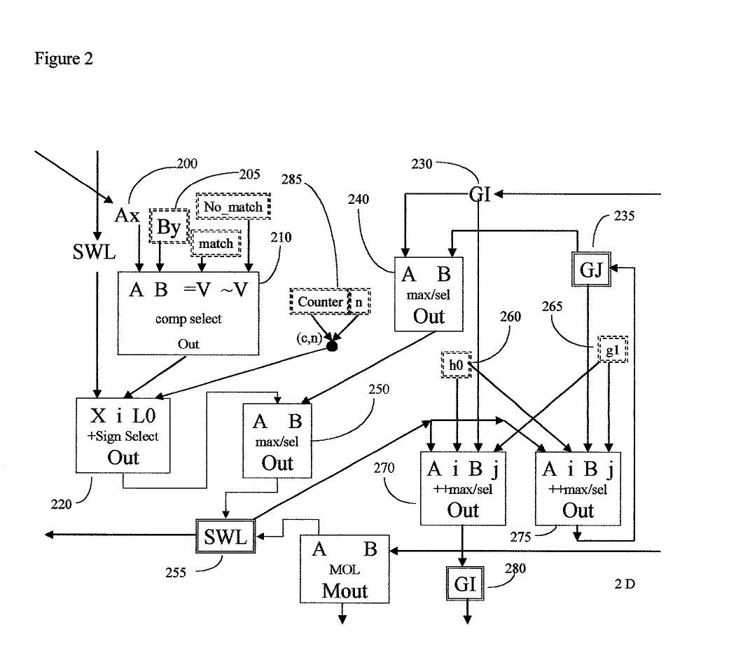

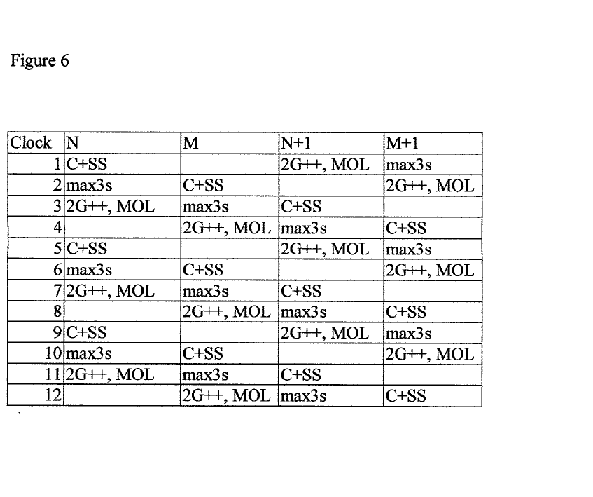

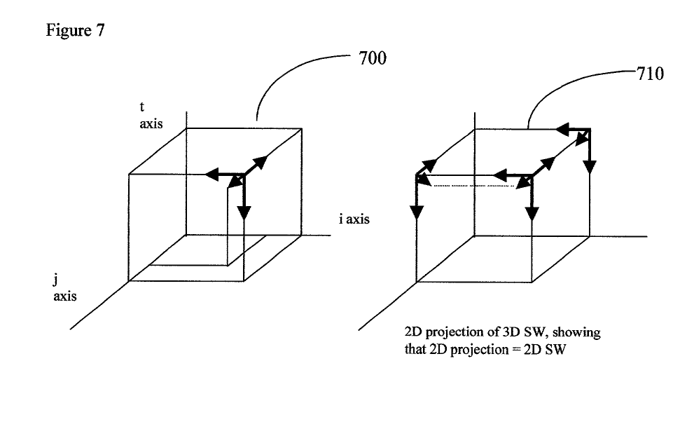

By comparison in FIG. 2, the SWL value need only go through an Adder, one Max function and one Maxs function. It should be noted here, that while prior art such as that shown in FIG. 1 occasionally delineates the number of signals or width associated with a line with a number and slash through the line as in (42), other signal line widths are not defined such as (43), and are left to the reader to assume. In this patent the reader should assume all signal line widths in all of the subsequent FIGS. 2 through 12, except FIGS. 6 and 7, to consist of multiple bit lines. The actual widths will vary and should be defined by the size of the problem, and therefore the size of the numeric calculations required, but should at least be 16 bits wide, and preferably 32 bits wide or larger.

FIG. 2 shows a processor constructed improving on the teachings of prior art. This is analogous to the processor taught in FIG. 1 with some added efficiency. In the prior art, during the clock cycles between the start of the operation, and the computation of the final Smith-Waterman value, many of the subunits are used only a small fraction of the time. Typically many subunits are idling while either waiting their turn, or after their turn. In the improvement, as per the prior art, the various circuit elements accept characters from two input character strings, and over a number of clock cycles, make a comparison, bring in the other Smith-Waterman data from neighboring processors, determine a local maximum, and then pass the Smith-Waterman results along to the next processor. In the improvement, the calculation proceeds with the input of the Ax string element(200) and the comparison with the static registered value By (205). In one clock cycle these are compared, converted to a comparison value (210), which is added to the incoming SWL and checked for negative values (220). At the same time the current GI (230) and GJ (235) values are being compared (240). The maximum of zero or the new SWL is then compared with the maximum of GI and GJ (250). The maximum of this comparison is stored in the SWL register (255). At the same time the prior value of SWL plus h0 (260) is compared with the prior values of GI and GJ plus g1 (265). The maximum of the resulting sums (270, and 275) are being stored in the GI (280) and GJ (235) registers on the next cycle. The calculation of one Smith-Waterman cell takes 2 cycles but subsequent calculations can begin on each cycle. This simple two stage pipe gives a significant efficiency to this approach, over the prior art, since the critical path is one addition, a sign select and a maximum calculation, compared to two additional maximum functions in the prior art. (In this drawing, the double lined boxes are registers, and the dashed double lined boxes are static latches.)

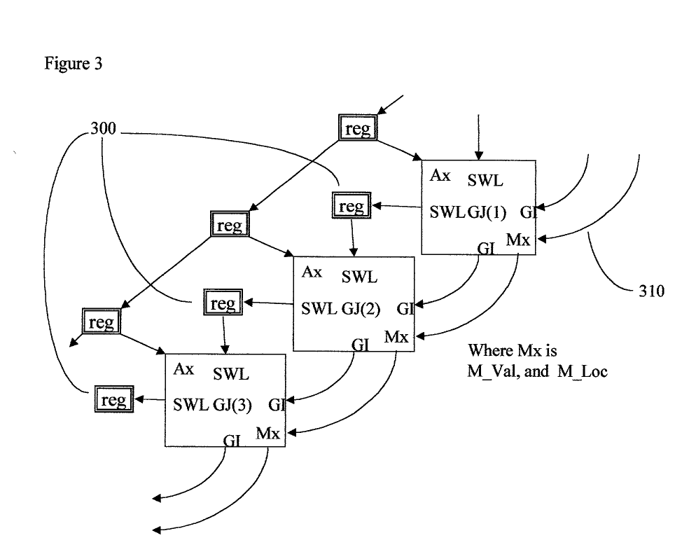

FIG. 3 shows how a plurality of processors interconnects on an integrated circuit chip, following the teaching of prior art. Registers hold information for one clock cycle until the processor has completed one full Smith-Waterman computation, and then pass information along to the next processor. The extra register between the SWL output and input (300) is needed to stage the diagonal calculation properly, as taught in the prior art. The Mx reference (310) is the origin of the maximum comparison string. This calculation is necessary to determine where the best match occurred. The GJ values stay within each processor, as they are the calculation of the row values. The counter/n (285) in FIG. 2 is the origin location, which must be carried on during the Mx calculation.

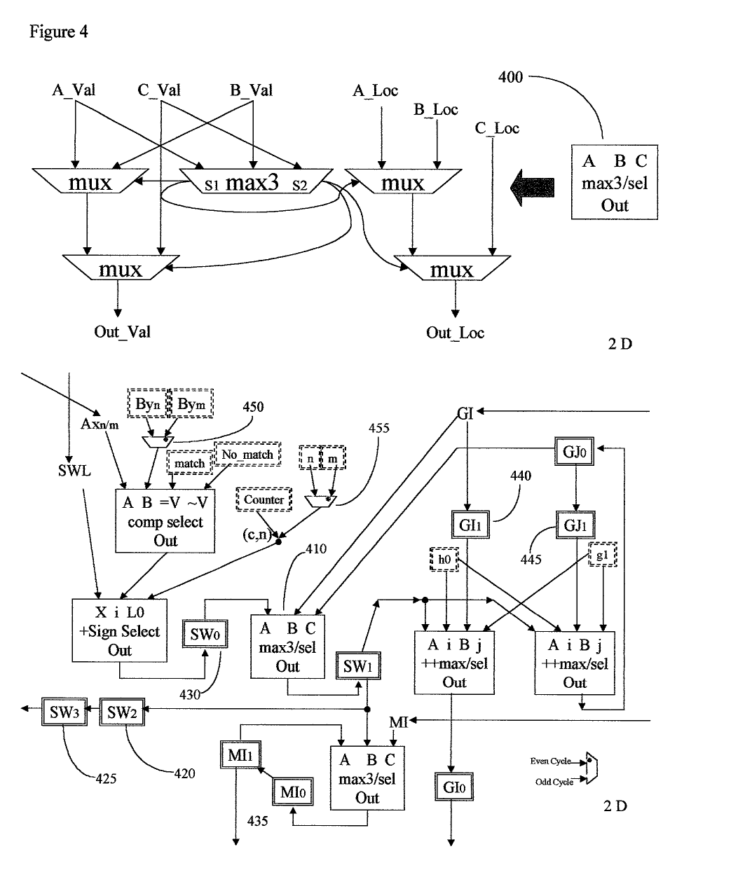

FIG. 4: A diagram showing an improved processor circuit. Here, the improved processor utilizes its components more efficiently by starting a second comparison operation executing before the first comparison operation is complete. By adding more registers, in the middle of operations previously done on one cycle, the clock frequency can be increased. The longest path in the FIG. 2 was from the comparison (210) to the SWL register (255). In the improved version the SWL computation path is split into two cycles, which allows the improved processor to correspondingly increase the clock frequency. Furthermore, the two stage two way maximum/selection operations (240, and 250) in FIG. 2 have been replaced with a 3 way maximum/selection operation (410) in the second stage of the SWL calculation, to balance the next critical path of GI and GJ contributions to SWL. This operation is only slightly longer than a two-way comparison. As can be seen in the associated drawing of max3/sel (400) in FIG. 4.

Each Smith-Waterman calculation still takes 2 clock cycles to pass it's information on to the next engine, so the alternate cycle can be used to complete another unassociated operation. By interleaving the pipeline, all units in the diagram in FIG. 4 are productive on every clock cycle. This results in a somewhat larger dedicated processor than the diagram in FIG. 2, but it can do twice as much in a shorter clock cycle.

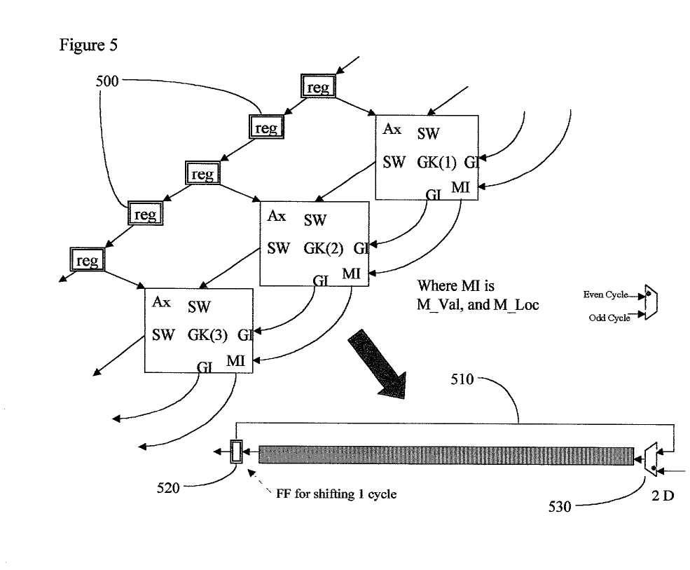

FIG. 5 shows how a plurality of improved processors interconnect on an integrated circuit chip. Registers SW2 (420) and SW 3 (425), shown in FIG. 4, hold the SW value for the next processor, which eliminates the need for the intervening register (300), between processors, shown in FIG. 3.

In the improved processors, two independent calculations can occur one cycle removed from each other. This is done by interleaving the separate values of Ax, which requires the additional staging registers (500) as compared to FIG. 3 above. Thus the computational string cycles back through a second time. Essentially the processor's connection architecture folds back on itself (510).

As a result the improved processors are smaller and faster than prior art. Processor size (in terms of transistor or gate count) per unit of processing capability is effectively decreased because the interleaving circuitry. which effectively doubles output, requires only the addition of a few additional registers (employing a small number of transistors or gates) to the non-interleaved circuit of prior art.

In the design shown here, each processor can handle two separate interleaved computations, with each computation taking two clock cycles to execute. Every function is active on every cycle, and less logic is executed between cycles. This is effectively one computation per clock cycle with clock cycles that are at least 3 times faster than prior art, which more than offsets the additional register logic.

FIG. 6 shows how the efficiency of processor component utilization can be improved by using interleaving techniques. By adding the additional registers (420,425,430,435,440, 445, and 500) shown in FIGS. 4 and 5 and the additional mux switches (450, 455, and 530) (shown in gray in FIGS. 4 and 5), the improved processor can handle two separate operations simultaneously. Here there are 3 cycles in each operation, with two cycles between each operation and the next logical operation N−>N+1 or M−>M+1. The components that are not used every other cycle above are used for a totally separate cell calculation. To minimize the top-level logic, one additional clock cycle is added at the end of the string (520) to shift the contents from the N,N+1 calculations to the M,M+1 calculations.

In addition to enabling faster and more economical 2D bioinformatic systems to be constructed, the processor optimization techniques taught herein enable the construction of novel types of specialized processors dedicated to higher dimensional sequence (three or more) analysis systems.

FIG. 7 shows a diagram showing the relationships between the various cells required to do a simultaneous analysis of three different input character strings or arrays, such as three different nucleic acid sequences. The left side (700) shows that for a 3D generalized Smith-Waterman type calculation, a processor calculating any given cell location will use values from processors computing the values for nearby cell locations in all three dimensions. The right side (710) illustrates graphically that upon projection back to two dimensions, the 3D generalized Smith-Waterman type cell analysis gives results equivalent to the standard 2D Smith-Waterman type analysis. That is, if for any one dimension, if all results for that particular dimension are “don't care” (weight=0), then the results for the remaining two dimensions will be equivalent to a standard 2D Smith-Waterman type analysis.

Here a given match between any three characters from the three input character strings is compared to the previous I−1, J−1, K−1 match between the three strings, as well as other combinations, each representing a different possible combination of insertion or deletion events between the three strings. This is done according to the formula:

SW[i,j,t]=max{SW[i−1,j−1,t−1]+s(a[i],b[j],c[t]); SW[i−k,j,t]+g[I]; SW[i,j−k,t]+g[j]; SW[i,j,t−k]+g[t]; 0}

i is the sequence index in sequence 1

j is the sequence index in sequence 2

t is the sequence index in the test sequence

k is a variable length gap

One difference between the new higher dimensional string comparison processors taught here, and previous two dimensional string comparison processors, is that the criterion for a match between given string characters is not necessarily a simple: Does character[I]=character [j]? test. Rather, it is often preferable to use a “two out of three or three out of three” consensus logic function. Many different consensus functions are possible, some examples are:

Assume string 1 is given weighting factor a, string 2 is given weighting factor b, and string 3 is given weighting factor c, then an exemplary consensus function “C”, used for computing the various SW components is:

$$\begin{matrix}C [ I , j , k ] = a + b ( If Sting1 [ i ] = String2 [ j ] ) ; \text{or} \\ a + c ( If String1 [ i ] = String3 [ t ] ) ; \text{or} \\ b + c ( If String2 [ j ] = String3 [ k ] ) ; \text{or} \\ a + b + c ( if String1 [ i ] = string2 [ j ] = string3 [ k ] ) \text{or} \\ 0 ( if String1 [ i ] ◇ String2 [ j ] ◇ String3 [ k ] )\end{matrix}$$

or alternatively:

$$\begin{matrix}C [ I , j , k ] = a * b ( If Sting1 [ i ] = String2 [ j ] ) ; \text{or} \\ a * c ( If String1 [ i ] = String3 [ t ] ) ; \text{or} \\ b * c ( If String2 [ j ] = String3 [ k ] ) ; \text{or} \\ a * b * c ( if String1 [ i ] = string2 [ j ] = string3 [ k ] ) \text{or} \\ 0 ( if String1 [ i ] ◇ String2 [ j ] ◇ String3 [ k ] )\end{matrix}$$

Many other types of consensus functions are possible. By giving “partial credit” for “two out of three matches”, and greater credit for “three out of three matches”, etc., three and higher dimensional comparisons may uncover faint similarities that two-dimensional analysis may miss. If more then three input arrays are being compared, the consensus function will be altered accordingly (e.g. “three out of four”, etc.). Here these consensus functions will be designated as “two out of three or three out of three” functions, but it should be understood that this designation will apply to consensus functions for more than three input arrays as well.

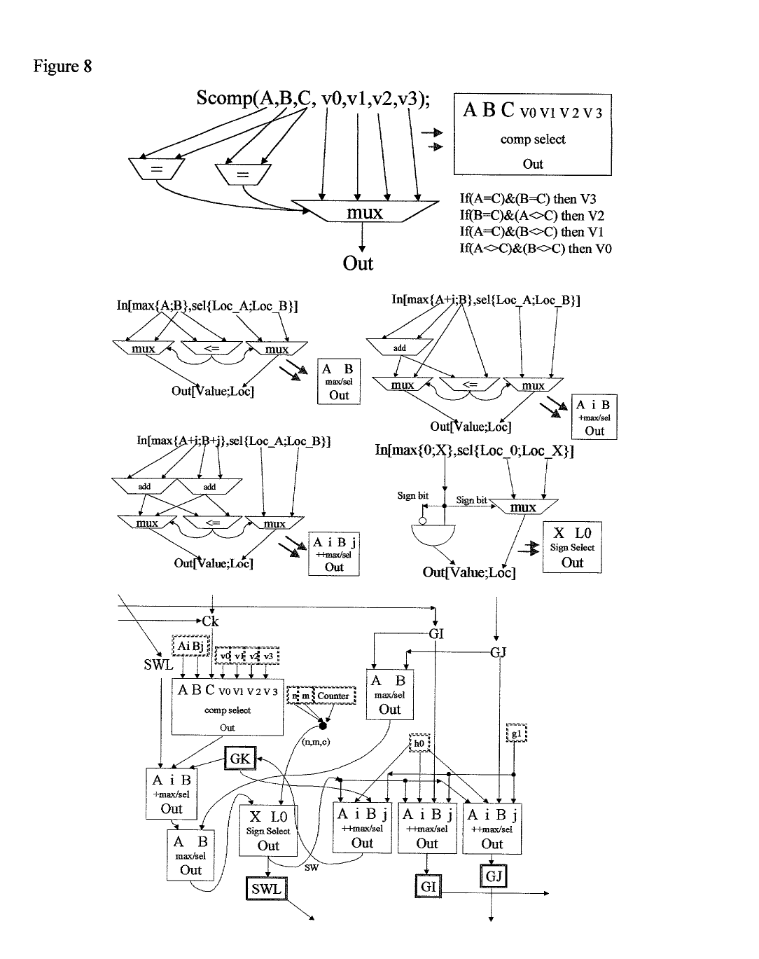

FIG. 8 shows an example of a processor optimized to perform three-dimensional comparisons between strings (arrays), using the higher dimensional form of the Smith-Waterman algorithm shown in FIG. 7 and described above.

Just as it is possible to implement a two-dimensional Smith-Waterman analysis in a one-dimensional array of processors by computing along the diagonal of a two dimensional matrix, so it is possible to implement a three dimensional Smith-Waterman style analysis in a two-dimensional array of processors, by computing along a planar cut through the three dimensional array.

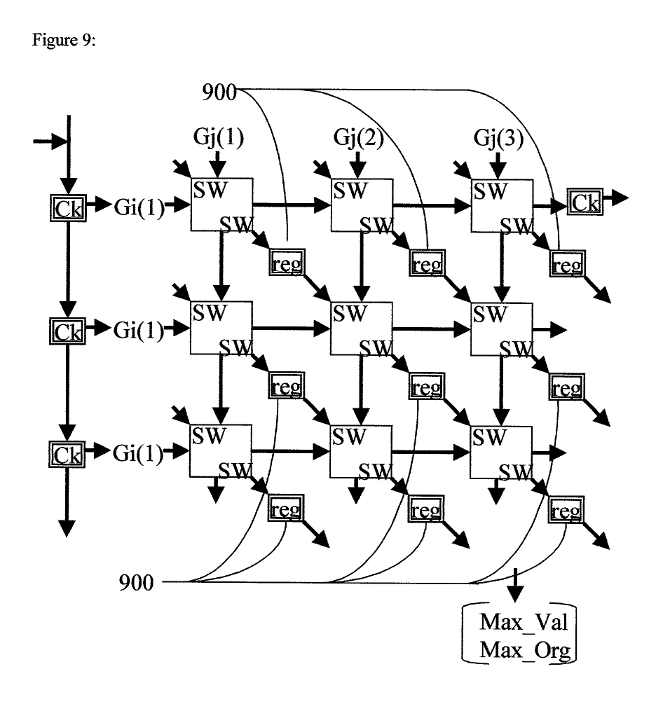

FIG. 9 shows how a plurality of three-dimensional string comparison processors can interconnect on an integrated circuit chip.

As for the two dimensional case, the three dimensional processors can either complete their 3D Smith-Waterman cell computations, and pass the results along in a register(900), or also use interleaving techniques to perform multiple 3D Smith-Waterman cell computations simultaneously.

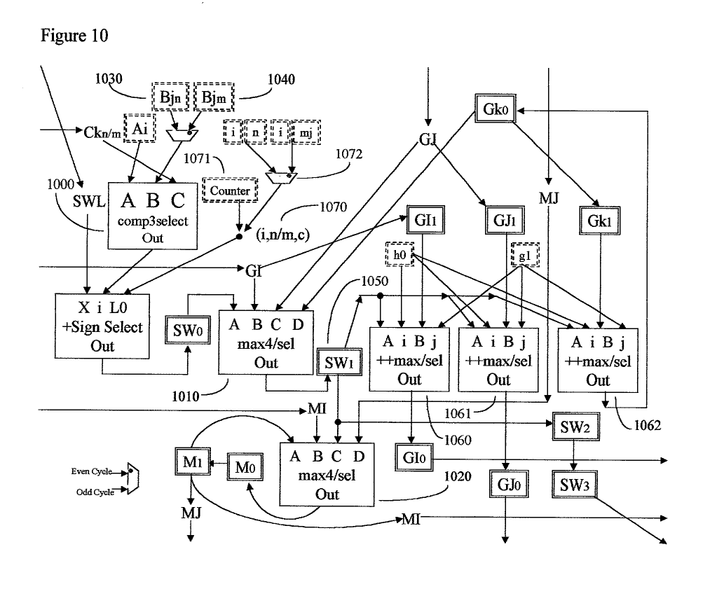

FIG. 10 is a diagram of an interleaved version, in the same manner as FIG. 4, of the three-dimensional processor shown in FIG. 8. This has the same set of functions as FIG. 4, but includes the third dimension shown logically in FIG. 8. There are two different functions; comp3select (1000) and max4/sel (1010, and 1020) than were shown in FIG. 8. Similar to FIG. 4, this interleaved processor produces an SW result every 2 cycles and can alternate processing two different comparisons signified by Bjn (1030) and Bjm (1040) above. In a similar fashion to FIG. 4, all the external registers have been included in this diagram. The diagram of operation of this embodiment of an interleaved three-dimensional processor is the same as shown in FIG. 2, but for three dimensions instead of two. On the first cycle the three strings are compared, on the second cycle the maximum of all four elements is performed to output SW1 (1050), the calculated value of the cell. On the next cycle the three column, row and height (GI,GJ, and GK) coefficients are updated, along with the maximum (1060,1061, and 1062). The three-dimensional location is shown as a 3-tuple [i,n/m,count]. (1070). The count increments every two cycles (1071). Every other cycle n or m are alternatively chosen for the current location of the cell be processed (1072).

The comp3select (1100) function in FIG. 11 has 4 separate values for each possible combinations of comparing the three strings. The max4 (1110) function shows a single bus bit's maximum logic. The AND/OR/MUX (1120) logic is repeated for each bit in the words A through D, and is connected from the highest order to the lowest order bit. If a strict maximum occurs only one of the Sa through Sd bits is still high at the lowest order bit comparison. The resulting Sa-Sd are encoded (1130) for use in the max4/sel function. In a manner similar to Addition, look-ahead logic may be added to minimize the number of gate levels in real operation.

FIG. 12 shows the interconnection of multiple interleaved, three-dimensional processors. In a manner similar to FIG. 9, the processors are connected into a two dimensional array. Processing begins on every other cycle until the results are passed out of the last processors on the right. The results are then fed into a single register for Gi and a single register for SW (1200) and fed back into the array to be processed on the second of every two cycles. This single register shifts the results from even operation to odd. In the example above the engine should be executed for a total of 24 cycles. The maximum value of all the cells calculated and the origin of the C string for that cell are available on the outputs (1210) two cycles after the last calculated SW value is calculated.

Note the interleaving is only in one direction. Interleaving in more than one direction requires more clock cycles of operation, and hence more registers. For example, to interleave in two directions requires 4 clock cycles per operation, with each quadrant of the unfolded calculations taking on clock cycle. This would require 4 additional registers for SW and two additional registers for all the other operations.

1: An improved special purpose processor, a plurality of which are embedded into an integrated circuit chip used to compare two or more input linear character arrays;
wherein the improved processor performs the operations of:
retrieving one character from each input array;
comparing the respective input characters;
adding the results of the comparison to a function based on the comparison results obtained from neighboring processor circuits of the same type that are analyzing different parts of the input arrays;
and determining the maximum of such comparisons with neighboring processors;
wherein the improved processor starts a second comparison operation executing before the first comparison operation is complete.

2: The processor of claim 1, wherein the processor interleaves results from a neighboring processor of the same type during each comparison analysis so as to perform multiple comparison operations during at least some of the same clock cycles.

3: The processor of claim 1, wherein the outputs from the processor includes comparison data and pointers to regions of higher homology between the two or more input arrays.

4: The processor of claim 1, wherein the input arrays contain biological nucleic acid sequence or protein sequence data, and the comparison between the input arrays is a Smith-Waterman type analysis.

5: The processor of claim 1, wherein each processor handles two separate interleaved computations, each computation taking two clock cycles to complete.

6: The processor of claim 1, wherein the processor includes means to interleave the calculation pipeline so that the logical units in the processor are productive on every clock cycle.

7: The processor of claim 6, wherein the means to interleave the calculation pipeline include additional registers.

8: An improved special purpose processor, a plurality of which are embedded into an integrated circuit chip used to compare two or more input linear character arrays;
wherein the improved processor performs the operations of:
retrieving one character from each input array;
comparing the respective input characters;
adding the results of the comparison to a function based on the comparison results obtained from neighboring processor circuits of the same type that are analyzing different parts of the input arrays;
and determining the maximum of such comparisons with neighboring processors;
wherein the improved processor contains additional registers enabling the calculation pipeline to perform two separate interleaved computations per clock cycle.

9: The processor of claim 8, wherein the outputs from the processor includes comparison data and pointers to regions of higher homology between the two or more input arrays.

10: The processor of claim 8, wherein the input arrays contain biological nucleic acid sequence or protein sequence data, and the comparison between the input arrays is a Smith-Waterman type analysis.

11: A special purpose electronic circuit for performing similarity analysis between three or more input linear character arrays, said circuit being divided into a plurality of processors, each processor performing the operations of:
retrieving one character from each of the various input arrays;
comparing the various characters and determining if there is a consensus between two or more of the input characters;
adding the results of the comparison to a function based on the comparison results obtained from neighboring subunits that are analyzing different regions of the various input arrays;
and determining the maximum of such inputs from neighboring subunits; wherein inputs to the electronic circuit include data from the various input arrays, and outputs from the electronic circuit include comparison data and pointers to regions of higher homology between two or more of the input arrays.

12: The electronic circuit of claim 11, wherein the input arrays contain biological nucleic acid sequence or protein sequence data, and the comparison between the input arrays is a multi-dimensional generalization of the Smith-Waterman type analysis.

13: The electronic circuit of claim 11, wherein a consensus between two or more of the characters is performed using a two out of three or three out of three consensus logic function.

14: A special purpose processor, a plurality of which are embedded into an integrated circuit chip used to compare three or more input linear character arrays,
wherein the processor performs the operations of:
retrieving one character from each of the various input arrays;
comparing the various characters and determining if there is a consensus between two or more of the characters using a first function;
adding the results of the first comparison function to a second function based on the comparison results obtained from neighboring subunits that are analyzing different regions of the various input arrays;
and determining the maximum of such inputs from neighboring subunits;
wherein inputs to the electronic circuit include data from the various input arrays, and outputs from the electronic circuit include comparison data and pointers to regions of higher homology between two or more of the input arrays.

15: The processor of claim 14, further comprising the improvement wherein the improved processor interleaves results from a neighboring processor of the same type during each character comparison analysis so as to start a second comparison operation executing before the first comparison operation is complete.

16: The processor of claim 14, in which the first consensus function is a two out of three or three out of three consensus logic function.

17: The processor of claim 14, wherein the input arrays contain biological nucleic acid sequence or protein sequence data, and the comparison between the input arrays is a multi-dimensional generalization of a Smith-Waterman type analysis.
